(19) United States
(12) Patent Application Publication
(10) Pub. No.: US 2002/0083019 A1
(43) Pub. Date: Jun. 27, 2002

(54) Verifying digital signatures using a postal security device

(76) Inventors: Eugene Robert Bystrak, Wolcott, CT (US); Rana Dutta, Shelton, CT (US); James Michael Mattern, Cheshire, CT (US)

Correspondence Address: Geza C. Ziegler, Jr., Perman & Green, LLP, 425 Post Road, Fairfield, CT, 06430, US

(21) Appl. No.: 09/950,380

(22) Filed: Sep. 10, 2001

Related U.S. Application Data
(60) Provisional application No. 60/231,614, filed on Sep. 11, 2000.

(51) Int. Cl. G06F 17/00; G06F 17/60

(52) U.S. Cl. 705/401; 705/60

(57) ABSTRACT

A system for verifying printed indicia. The system comprises an indicia generating apparatus adapted to create digitally signed indicia on an item having an associated value and an indicia verifying apparatus adapted to read the indicia on the item and verify that the item is valid. The item can be used as payment for a good or service.

### CROSS-REFERENCE TO RELATED APPLICATIONS

The present application claims the benefit of U.S. Provisional application Serial No. ______, filed on Sep. 11, 2000, and which is incorporated herein by reference.

### BACKGROUND OF THE INVENTION 1. Field of the Invention

The present invention generally relates to crypto-vault systems and in particular to verifying digital signatures.

2. Brief Description of Earlier Developments

There are many applications being developed by numerous vendors that utilize digital signatures to add higher levels of security to information and data. The U.S. Postal Service has sponsored the Information Based Indicia Program (“IBIP”), which uses these digital signatures in a new form of postage evidencing indicia. Since these digital signatures can be used for postage indicia, which are considered to be equivalent to money, applications such as ticketing, secure branding and e-commerce transactions can all utilize digital signatures to produce secure indicia for payment evidencing.

In general these digital signatures are generated using a computer, a standard printer and a secure cryptographic module, which securely stores and dispenses money and computes and transmits digital signatures associated with the money transactions performed by the cryptographic device. This digital signature can then be applied in printed form using a two-dimensional barcode or other means.

Once the digital signature is generated and printed, it is then necessary to verify these indicia for user authentication and data integrity, i.e., that the data signed by the crypto-vault has not been altered. This verification is typically the step performed by the merchant or vendor who has promised to provide the goods and/or services to the customer who holds the document that contains the digital signature based indicia. Once the signature is verified, then the merchant can be assured that proper payment has been made for the goods and/or services to be rendered.

### SUMMARY OF THE INVENTION

The present invention is directed to, in a first aspect, a system for verifying printed indicia. In one embodiment, the system comprises an indicia generating apparatus adapted to create digitally signed indicia on an item having an associated value and an indicia verifying apparatus adapted to read the indicia on the item and verify that the item is valid. The item can be used as payment for a good or service.

In another aspect, the present invention is directed to a system for verifying digital signatures. In one embodiment, the system comprises at least one digital imaging device adapted to read a digital signature from a medium, a database of previously read digital signatures, and a controller coupled to the digital imaging device. The controller is adapted to compare the digital signature to the database of previously read digital signatures to determine a validity of the digital signature.

In a further aspect, the present invention is directed to a method of verifying an authenticity of a ticket. In one embodiment, the method comprises reading a digital signature on the ticket using a digital imaging device coupled to an indicia verification system, decoding the digital signature, and determining the validity of the ticket. The validity of the ticket can be determined by comparing the decoded digital signature to a database of previously read digital signatures. If the decoded digital signature is not in the database of previously read digital signatures, the ticket is valid.

### BRIEF DESCRIPTION OF THE DRAWINGS

The foregoing aspects and other features of the present invention are explained in the following description, taken in connection with the accompanying drawings, wherein:

FIG. 1 is a block diagram of a system incorporating features of the present invention.

FIG. 2 is a representation of a digital image on an exemplary ticket that can be used in a system incorporating features of the present invention.

FIG. 3 is a representation of a scanner that can be used in a system incorporating features of the present invention.

FIG. 4 is a block diagram of an embodiment of a system incorporating features of the present invention.

FIG. 5 is a block diagram of a verifier system that can be used in a system incorporating features of the present invention.

FIG. 6 is a block diagram of an embodiment of a system incorporating features of the present invention.

FIG. 7 is a flow chart of a method incorporating features of the present invention.

FIG. 8 is a block diagram of one embodiment of a postal security device system.

FIG. 9 is another embodiment of a postal security device system.

FIG. 10 is an embodiment of an open system postal security device system.

### DETAILED DESCRIPTION OF THE PREFERRED EMBODIMENT

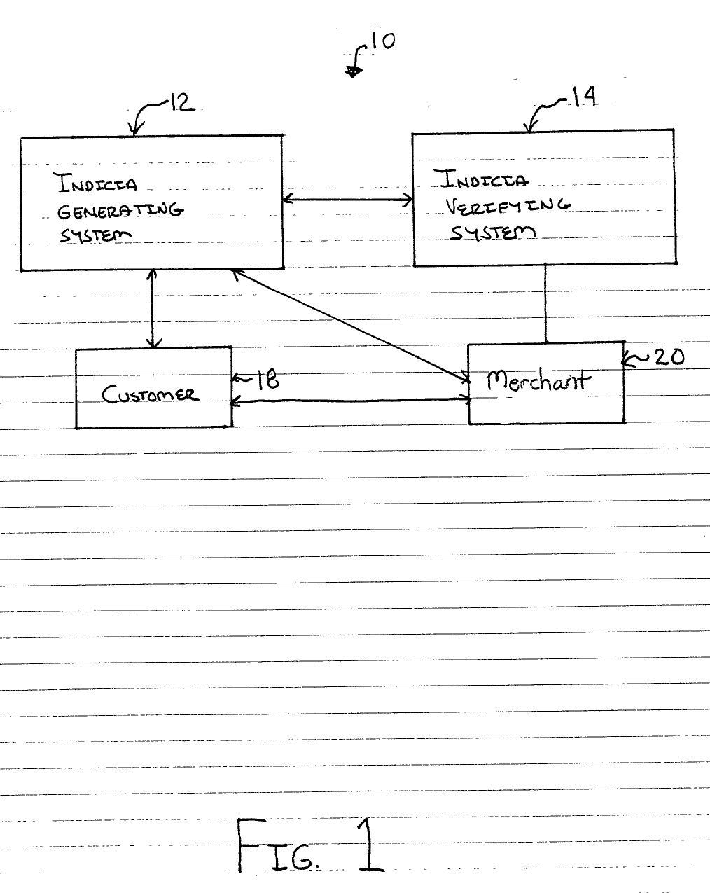

Referring to FIG. 1, a block diagram of a system 10 incorporating features of the present invention is shown. Although the present invention will be described with reference to the embodiments shown in the drawings, it should be understood that the present invention can be embodied in many alternate forms of embodiments. In addition, any suitable size, shape or type of elements or materials could be used.

Referring to FIG. 1, the system 10 generally comprises an indicia generating system 12 and an indicia verifying system 14. In alternate embodiments the system 10 can include such other suitable components and systems adapted to generate and verify digitally signed indicia.

The system can also include one or more customers 18 and one or more merchants 20. The customers 18 and merchants 20 are generally adapted to communicate with each other and the indicia generating system 12 and the indicia verifying system 14.

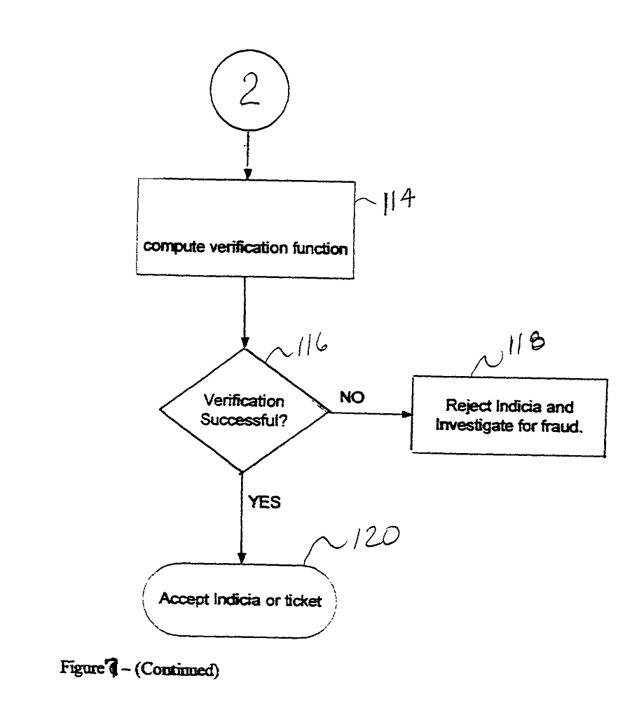

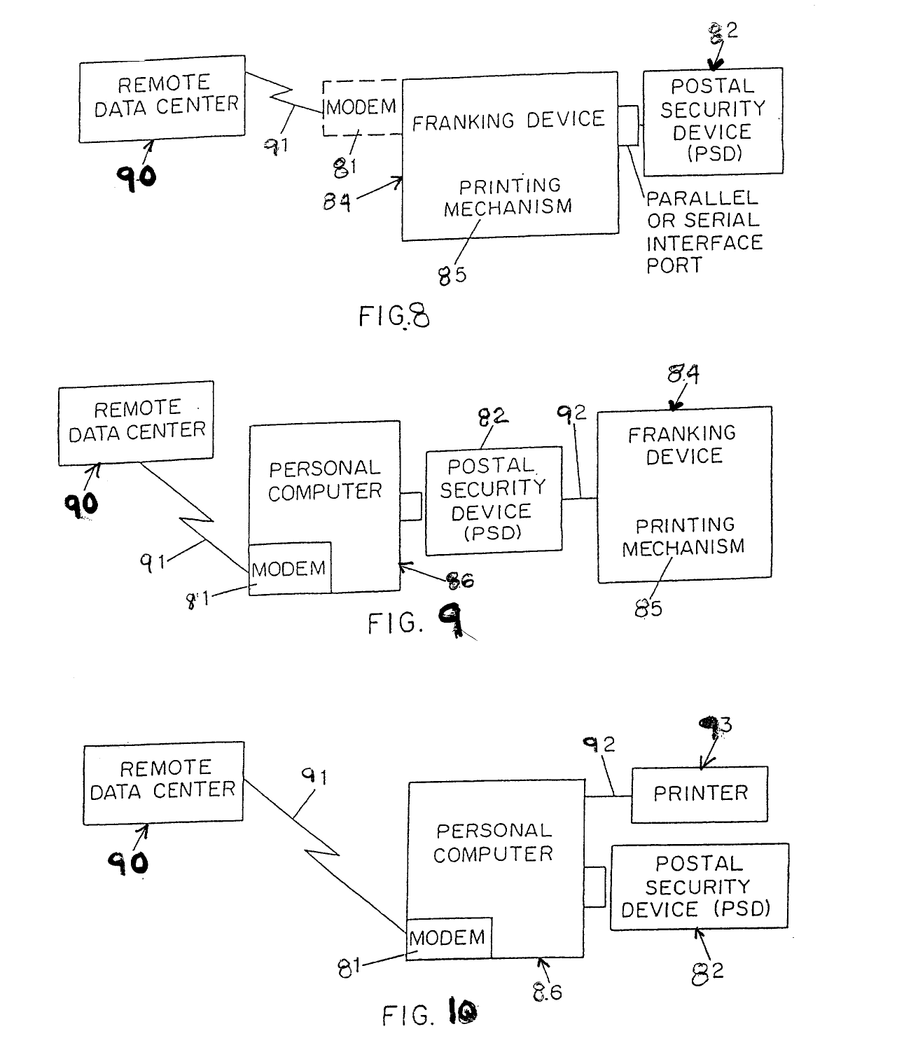

The indicia generating system 12 generally comprises a crypto-vault, such as for example, a postal security device (“PSD”), which is adapted to create digitally signed indicia. Such a postal security device is described in U.S. Pat. No. 6,009,417, and co-pending application number (Attorney Docket No. 770P009679-US(PAR)), each of which is commonly assigned to the assignee of this application, and incorporated herein by reference. The postal security device generally comprises a physical hardware device. Alternatively, the postal security device can comprise a virtual device that can include for example, an Internet service or server adapted to provide physical postal security device functionality. Generally, the indicia generating system 12 comprises a postal security device adapted to generate postal indicia for postage evidencing. The PSD is generally in a physical secure housing and can include cryptographically secure funds and associated accounting registers. The PSD is generally utilized in a dynamic system that provides for the interchange of data between a funds provider source, a computational funds tracking and maintenance source and a printing source. Whether an Open System (OS) or a Closed System (CS), the PSD provides all security against fraudulent attacks against the system. The PSD provides customers with a number of alternative approaches to optimize the customer's use, tracking and replenishing of the customer's franking funds within the environment surrounding the dispensing of funds for proof or payment. The proof of payment, indicium, is digitally generated data. The data can be represented as an image on the piece requiring the proof of payment. The proof of payment can be represented for example, as a graphical image, human readable information, various bar codes (both one and two-dimensional), OCR characters, or any combination thereof. A closed system approach generally provides a printing device within the franking device or within a cryptographically secure boundary as executed by a vendor or merchant. The franking device is generally dedicated to the imprinting of proof of payment and will take any desired form. The cryptographic content of the printed indicia image generally includes information unique to that transaction and the specific PSD. For example, referring to FIG. 8, in one embodiment of a closed system, the PSD 82 is attached as an adaptive interfacing device that connects to and uses a communications port while still allowing the port to be used by other devices to the self contained franking device 84. The cryptographic data content between the PSD 82 and the franking device 84 is verified for authenticity (e.g. signature certificate) whereupon the printing mechanism 85 within the franking device 84 delivers the appropriate image to the piece. Crediting new funds to the PSD can be managed by an interface, such as for example, a modem adapted to the franking device 84 which communicates cryptographically with a host data center 90 which provides funds for the PSD through the franking device 84. The communications between the franking device 84 and the data center 90, or between the franking device 84 and PSD 82 are cryptographically encoded with all transactions being verified by the cryptocode structure and certificate authorization schema as desired or required. The PSD 82 can be moved from one franking device 84 to another so long as each franking device 84 is authorized or keyed to function with the PSD 82. The PSD has the ability to account for funds and history as related to the franking device 84 to which it has been attached. The communications channel 91 between the franking device 84 and the data center 90 can be any type of desired communications channel. The PSD 82 can also include an accounting register indicative of funds value and contains cryptographic means adapted for secure communications with a remote host 90 for adjustment of the contents of the accounting register. The cryptographic means can generate data to be included in the indicia and disposed to account within the accounting register for funds value provided in the indicia and fail to generate that data when the accounting register satisfies a predetermined condition. Generally, the accounting register is a descending register and indicia are printed only if the value stored in the descending register is greater than the amount of postage value desired to be printed. The PSD 82 can also be internal to the franking device and funds crediting is managed by an interface to the franking device 84 which communicates cryptographically with the host data center 90. The PSD 82 can also be interfaced to a personal computer 86 as shown in FIG. 9. The PSD 82 is credited with funds via communications between the personal computer 86 and the data center 20. The PC 86 is programmed so that it can receive a request for the printing of indicia from a user and forward the request to the PSD 82. In an open system arrangement, the printing device 93 is located outside a franking device and can be any commercially available printing device. The cryptographic content of the printed indicia image contains information unique to that transaction and specific PSD. For example, as shown in FIG. 10, the PSD 82 can be interfaced to a personal computer 86 communication port.

In alternate embodiments, the indicia generating system 12 can include any suitable device or system adapted to produce secure indicia for payment evidencing, or both postal and payment evidencing. For example, the indicia generating system could be adapted to provide postal payment evidencing in accordance with United States Postal Service (USPS™) standards as well as payment evidencing for other merchant and carriers such as United Parcel Service (UPS™) and Federal Express (FedEx™). In one embodiment, the indicia generating system 12 could include the SAFE™ Crypto-Vault device manufactured by Ascom Hasler Mailing Systems, Inc. Alternatively, the indicia generating system 12 could comprise any device that uses the standard DSA, RSA encryption schemes, Elliptic Curve digital signatures along with standard Certificate Authority (“CA”) certificates or X.509 standards.

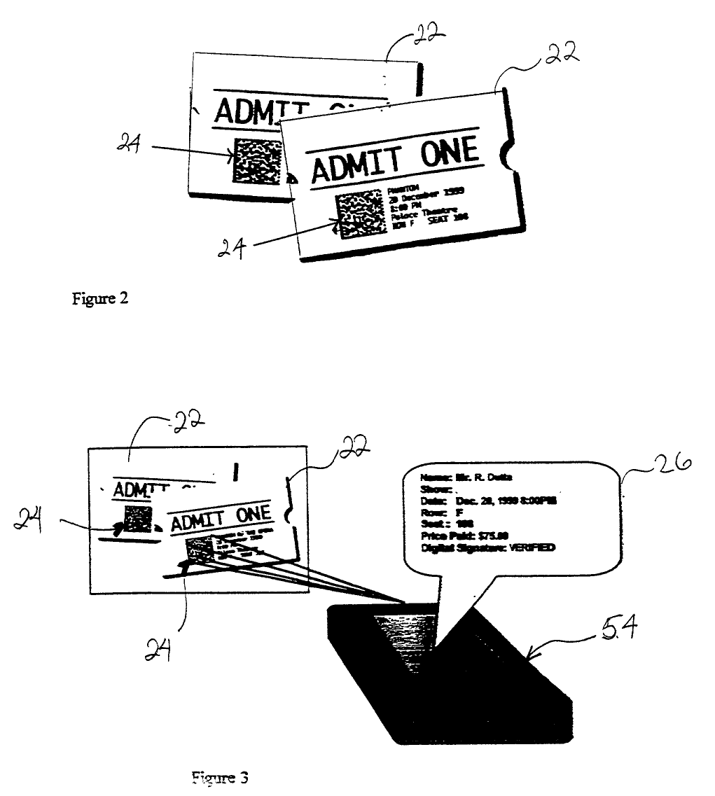

Referring to FIGS. 1 and 2, the indicia verifying system 14 is generally adapted to verify the digital signature incorporated or encoded into the indicia 24 generated by the indicia generating system 12. As shown in FIG. 2, in one embodiment, the indicia section 24 could be printed on a ticket 22, such as for example, a theater ticket. The ticket 22 can include other printed information in addition to the indicia section 24, such as for example discount coupons, driving directions, future events and souvenir photos. Also, the ticket could include indicia information for the payment of goods or services other than the merely the ticket. Additional payment options could include for example, parking fees, food or restaurant services, and souvenirs. The indicia section 24 generally includes the digital signature and can comprise any suitable indicia, such as for example, a bar code. Although the term “ticket” is used herein to describe the medium on which an indicia 24 is printed, it should be understood that any suitable medium on which the indicia 24 can be printed or imaged can be used.

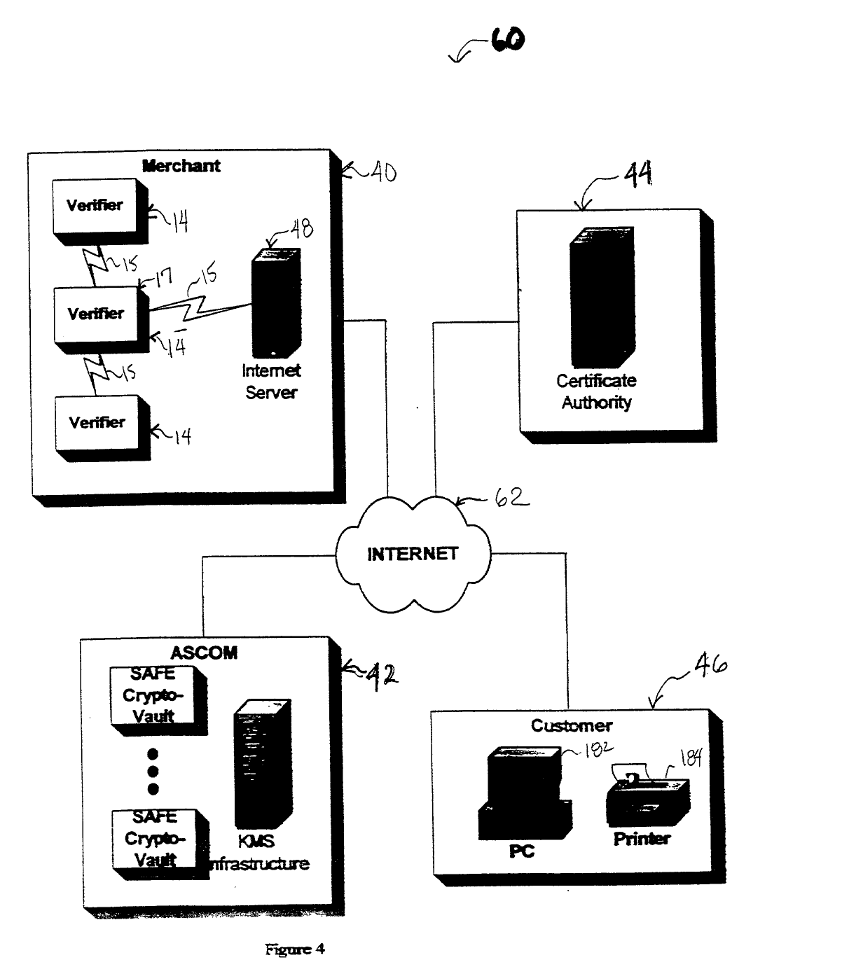

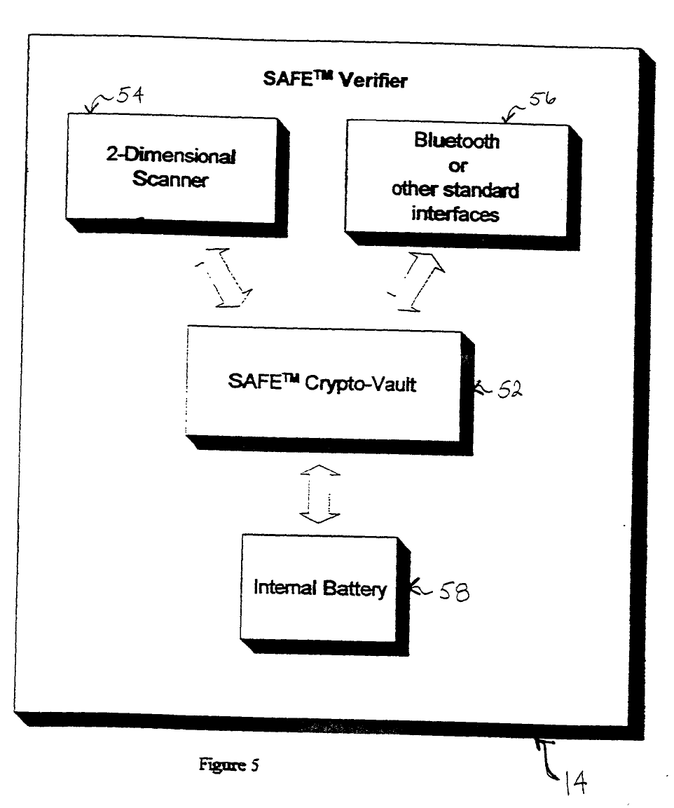

In one embodiment as shown in FIG. 5, the verifying system 14 can include a crypto-vault device 52 adapted to perform a verification function on digital signatures. Although similar to the crypto-vault device of the indicia generating system 12, the crypto-vault 52 generally includes modified software to allow it to perform the verification function. The verifying system 14 can also include a digital imaging device 54, which in one embodiment can comprise a scanner such as the example shown in FIG. 2. The digital imaging device 54 can generally include any device adapted to scan a one or two dimensional bar code format, such as for example PDF 147™ manufactured by Symbol Technologies, Inc., a Data Matrix™, or an Aztech™. For example, as shown in FIG. 3, the digital imaging device 54 is generally adapted to scan a digital image 24 on a ticket 22. The digital image 24 can also include other information in addition to the digital signature, such as for example, the information displayed in block 26. The scanned information can be transmitted to the crypto-vault device 52 for decoding and verification. In one embodiment, the verifier 14 shown in FIG. 5 can also include a wireless communication device or interface 56 adapted to allow the verifier 14 to communicate with other verifiers 14 in the system 10. The wireless communication interface 56 could include any desired communication interface, such as for example the Bluetooth™ form of wireless communication, or a standard-wired local area network (“LAN”) which allows the verifier 14 to communicate with other verifiers 14 in the same venue or application. In one embodiment of a system 10 including multiple verifiers 14, the communication device 56 is generally adapted to allow the verifiers 14 to be used in master-slave and peer-to-peer configurations. For example, referring to FIG. 4, a merchant verifier system 40 can include a plurality of verifiers 14 connected or coupled together via one or more communication channels 15 to a server or controller 48. In one embodiment, one of the verifiers 14 serves as a master verifier 17 and communicates directly with the server 48 while the other verifiers 14 communicate directly with the master verifier 17. The server 48 is generally adapted to establish and maintain communications with other components of a verifier infrastructure system 60, which can include for example a certificate authority 44, a crypto-vault infrastructure 42, and a customer system 46. In one embodiment, the verifiers 14 are networked to the server 48, which is connected or coupled to a communications channel 62, such as for example the Internet, for communicating with the other components of the system. In an alternate embodiment, the communication channel 62 can include any conventional communication pathway.

Referring to FIG. 4, the crypto-vault Key Management System (“KMS”) infrastructure 42 is generally adapted to manage the cryptographic keys that are used to create and manage the digital signatures. As shown in FIG. 4, the server 48 can also communicate with a third party certificate authority 44 to decode and obtain certificate information. Examples of such certificate authorities 44 can include Entrust™ and VeriSign™, among others. However, in an alternate embodiment the digital imaging device or scanner 54 of FIGS. 3 and 5 can read the certificate information in the digital image or bar code 24.

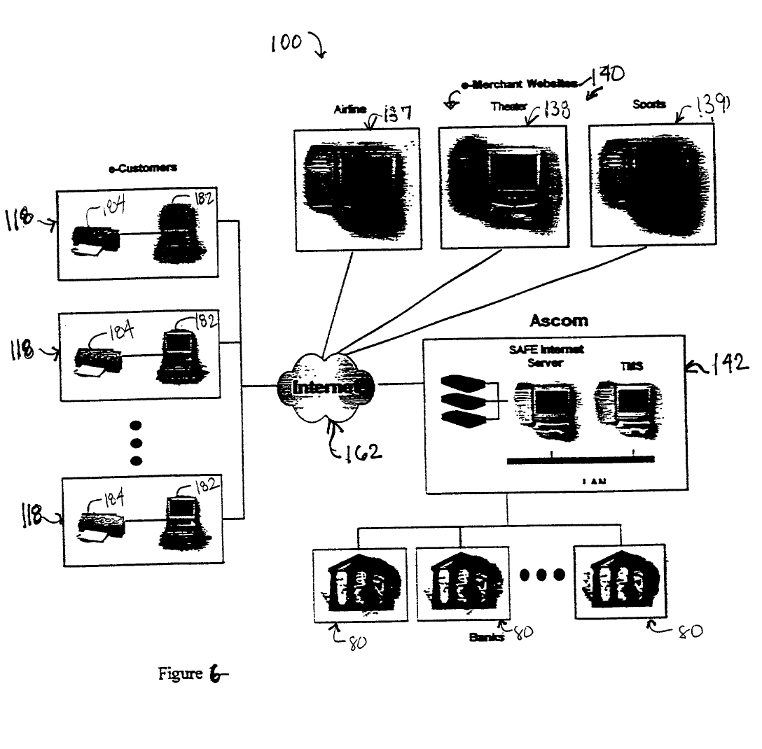

Referring to FIGS. 2 and 6, in one embodiment, the system 10 can comprise a system to generate and verify digitally signed tickets 22 for use with a merchant 140, such as for example, an e-commerce merchant (a merchant selling services or goods over the Internet). The merchant sites or websites 140 could include for example, an airline 137, a theater 138 or a sports venue 139. As shown in FIG. 6, the system can include one or more customers 118, one or more merchant or user sites 140, a crypto-vault system 142 and one or more banks, financial institutions or payment processing centers 80. A communication channel 162, such as for example the Internet, can be used to allow the customer sites 18, merchant sites 140 and crypto-vault system 142 to communicate with each other. As shown in FIG. 6, each customer site 118 can also include a computing device 182 and an associated printer 184. Each computing device 182 is generally adapted to communicate with the crypto-vault system 142 and communicate a request for digital indicia from the customer 118. The request for the digital indicia may also come from the merchant 140 who is in contact with the customer 118. Each customer 118 can have a respective printer 184 that is adapted to print the digital indicia including the digital signature. In a theater venue 138 for example, a user 118 may request a theater ticket 22 from a theater merchant 140 for a theater performance. The crypto-vault system 142, in conjunction with the theater merchant 140, can transmit the digital indicia, including the digital signature, to the customer 118. The customer 118 can then print a ticket 22 including the digital indicia 24 on the printer 184. With this theater ticket 22, the holder of the ticket 22, presumably the customer, travels to the location of the theater to see the show. The ticket holder can present the ticket 22 at the theater for admission. Using, for example, the scanner 54 shown in FIG. 3, an attendant at the theater, using a verifier 14, scans the information 24 and if verified, the ticket holder is granted admission to the theater. The scanned information can be transmitted back to the theater site 138, which can transmit the information to the appropriate site for verification. In order to check for duplicate tickets, a distributed database (not shown) can be created which stores the scan from the verifier 14 as each ticket 22 is scanned. When the verifier 14 scans the first ticket presented, a record of the ticket and the digital signature is created in the database. When a ticket 22 is scanned, the verifier 14 compares the digital signature on the ticket 22 against the database of previously scanned tickets 22. If a duplicate occurrence of a ticket 22 is detected, the verifier 14 can reject the subsequently presented ticket or initiate other suitable action. Other steps may be needed to identify the unauthorized copy of a ticket 22, such as for example, requiring the ticket holders to present identification, or requiring the ticket holders to identify or verify security and password information that was encoded into the ticket 22 at the creation of the original, authorized ticket. Generally, any conventional method can be used to authenticate the original ticket and ticket holder. In the embodiment where multiple verifiers 14 are used as shown in FIG. 4, the distributed database can be created among the verifiers 14. In this embodiment, the distributed database can reside in the master verifier 17. In alternate embodiments, the distributed database can reside in any suitable data storage device that communicates with the verifiers 14 for confirming data records.

In one embodiment, the verifier 14 shown in FIGS. 1 and 5 can comprise a small, modular hand-held verifying device. The device can be used to verify the digital signatures generated by a crypto-vault system, such as for example the SAFE™ crypto-vault system manufactured by Ascom Hasler Mailing Systems, Inc. The system 10 and verifier 14 can be adapted to be used in applications, such as for example, hand-held verification of IBIP indicia, digitally signed tickets, branding labels, or any other application in which a digital signature needs to be verified. In one embodiment, the verifier 14 can include a power supply comprising an internal battery 58 as shown in FIG. 5 so that the verifier 14 can be a small, handheld device. In an alternate embodiment, any suitable power source can be used for a power supply for the verifier 14.

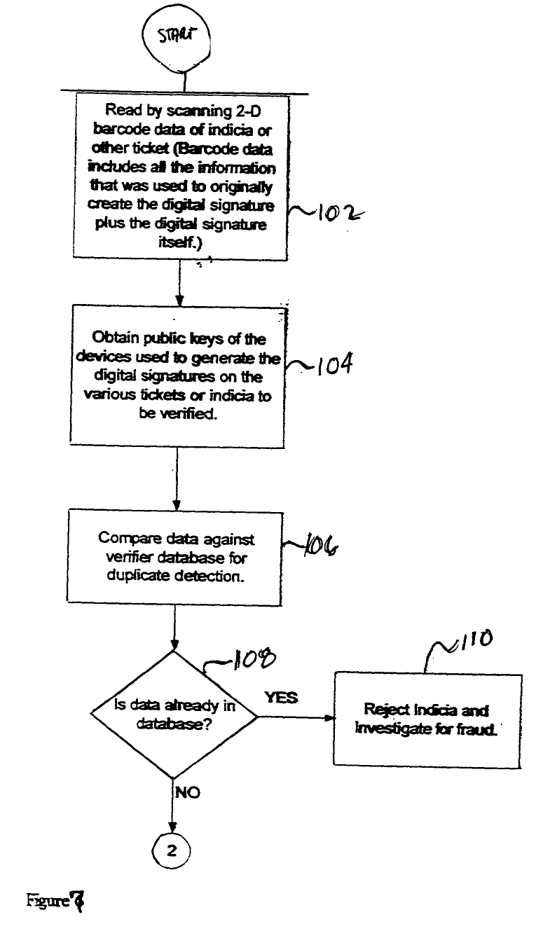

FIG. 7 is a flowchart of a method incorporating features of the present invention. Referring to FIGS. 4 and 7, the indicia information is read 102 from a ticket 22. The step of reading the indicia can include scanning a two-dimensional bar code data of indicia or other ticket. The bar code data generally includes all of the information that was used to originally create the digital signature plus the digital signature itself. The public keys of the devices used to generate the digital signatures on the indicia 24 on the various tickets 22 to be verified are obtained 104. As shown in FIG. 4, in one embodiment the keys can be obtained from the certificate authority 44, and can include for example, X.509 Certificates issued by the Certificate Authority for the digital signature generating cryptographic devices. Alternatively, the keys can be included within the barcode and read when scanned. The public keys can also be preloaded by scanning separate bar codes, such as for example two-dimensional bar codes, which contain the public keys for the devices that generate the indicia 24 on the tickets 22 to be verified. The scanned data can then be compared 106 against the verifier database for duplicate detection. If the scanned data is already in the database the ticket 22 can be rejected 110 or investigated. If the scanned data is not in the database, the verification function is computed 114. Generally, the verification function is a standard function dependent on the type of digital signature being verified. Types of digital signatures can include for example, DSA, RSA or Elliptic Curve DSA. If the verification is not successful, the ticket 22 including the indicia 24 is rejected 118. If the verification is successful, the ticket 22 can be accepted 120.

In one embodiment, by adding for example a bar-code imaging and scanning device plus some form of wireless communications system to a SAFE™ C-V device, together with related software, the SAFE™ system can be adapted to provide the new verification functions in addition to digital signature generation.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A system for verifying printed indicia comprising:
an indicia generating apparatus adapted to create digitally signed indicia on an item having an associated value; and
an indicia verifying apparatus adapted to read the indicia on the item and verify that the item is valid, wherein the item is then used as payment for a good or service.

2. The system of claim 1 wherein the indicia generating apparatus includes a postal security device.

3. The system of claim 1 wherein the indicia verifying apparatus includes a verifier adapted to detect and read the indicia on the item.

4. The system of claim 3 wherein the verifier comprises a digital imaging device.

5. The system of claim 3 wherein the verifier comprises a scanner adapted to scan a bar code on the item.

6. The system of claim 1 wherein the indicia verifying apparatus comprises a plurality of verifier devices, each verifier device adapted to communicate with a master verifier device.

7. The system of claim 6 further comprising a database coupled to the master verifier, the database including a record for each scanned item and wherein the database is adapted to provide the verifying apparatus with information associated with a validity of the scanned ticket.

8. The system of claim 1 further comprising a merchant site, the merchant site adapted to communicate with the indicia generating apparatus and the indicia verifying apparatus in order to transfer information associated with the indicia for the item between the merchant site and the indicia generating and indicia verifying apparatus.

9. The system of claim 1 further comprising a user site, the user site adapted to communicate with a merchant site and request an item containing the indicia.

10. The system of claim 9 wherein the user site further comprises a printer adapted to receive the indicia from the indicia generating apparatus and print the indicia on the item.

11. A system for verifying digital signatures comprising:
at least one digital imaging device adapted to read a digital signature from a medium;
a database of previously read digital signatures; and
a controller coupled to the digital imaging device and adapted to compare the digital signature to the database of previously read digital signatures to determine a validity of the digital signature.

12. The system of claim 11 wherein the digital imaging device is a portable device.

13. The system of claim 11 wherein the controller is further adapted to communicate with a certificate authority to obtain certificate information for the digital signature.

14. The system of claim 11 further comprising a merchant site from which information associated with the digital signature is obtained.

15. The system of claim 11 further comprising a user site, the user site adapted to request a digitally signed document from a merchant site, the merchant site adapted to communicate with a indicia generating system to transmit the digitally signed document to the user site, wherein the user site is adapted to print the digitally signed indicia onto a tangible medium, the tangible medium in combination with the digitally signed indicia representing an item of value.

16. A method of verifying an authenticity of a ticket comprising the steps of:
reading a digital signature on the ticket using a digital imaging device coupled to an indicia verification system;
decoding the digital signature; and
determining the validity of the ticket by comparing the decoded digital signature to a database of previously read digital signatures, wherein if the decoded digital signature is not in the database of previously read digital signatures, the ticket is valid.

17. The method of claim 16 further comprising the steps, prior to the step of reading the digital signature, of:
requesting a ticket of value from a merchant site;
receiving the ticket of value, the ticket of value including a digitally signed indicia provided from an indicia generating system, the ticket including the digitally signed indicia being adapted to be printed by a user.
